(19) United States
(12) Patent Application Publication
(10) Pub. No.: US 2008/0110932 A1
(43) Pub. Date: May 15, 2008

(54) METHOD OF VISUALLY ENHANCING INVERTED BOTTLE WATER COOLER

(76) Inventor: Greg B. Wilson, Courtenay (CA)

Correspondence Address: DAVIS BUJOLD & Daniels, P.L.L.C., 112 PLEASANT STREET, CONCORD, NH, 03301, US

(21) Appl. No.: 11/872,916

(22) Filed: Oct. 16, 2007

Related U.S. Application Data
(60) Provisional application No. 60/852,072, filed on Oct. 16, 2006.

(51) Int. Cl. B67D 3/00; F25D 31/00; B67D 5/62

(52) U.S. Cl. 222/146.6; 29/592; 62/389; 62/331; 222/185.1; 222/183

(57) ABSTRACT

A method of visually enhancing water cooler having a base unit which receives an inverted water bottle. A first step involves providing an annular tank having an annular bottom with a transparent exterior sidewall extending upwardly from the bottom making the contents of the annular tank visible and an interior sidewall extending upwardly from the bottom which defmes a cylindrical central cavity. The cylindrical central cavity is selectively sized to slide over an inverted water bottle. A second step involves sliding the annular tank over the inverted water bottle of the water cooler, until the inverted water bottle is positioned within the cylindrical central cavity of the annular tank with the bottom of the annular tank resting upon the base unit. A third step involves filling the annular tank with a visual attraction viewable through the transparent exterior sidewall.

### FIELD

The present invention relates to a method of visually enhancing an inverted bottle water cooler, and a combination apparatus in accordance with the teachings of the method.

### BACKGROUND

Inverted bottle water coolers are a fixture in many offices. They consist of a base unit having a cavity which is designed to receive an inverted water bottle.

### SUMMARY

According there is provided a method of visually enhancing water cooler having a base unit which receives an inverted water bottle. A first step involves providing an annular tank having an annular bottom with a transparent exterior sidewall extending upwardly from the bottom making the contents of the annular tank visible and an interior sidewall extending upwardly from the bottom which defines a cylindrical central cavity. The cylindrical central cavity is selectively sized to slide over an inverted water bottle. A second step involves sliding the annular tank over the inverted water bottle of the water cooler, until the inverted water bottle is positioned within the cylindrical central cavity of the annular tank with the bottom of the annular tank resting upon the base unit. A third step involves filling the annular tank with a visual attraction viewable through the transparent exterior sidewall.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of an annular tank in accordance with the method and combination disclosed herein.

FIG. 2 is a side elevation view of the annular tank of FIG. 1, positioned on an inverted bottle of a water cooler.

### DETAILED DESCRIPTION

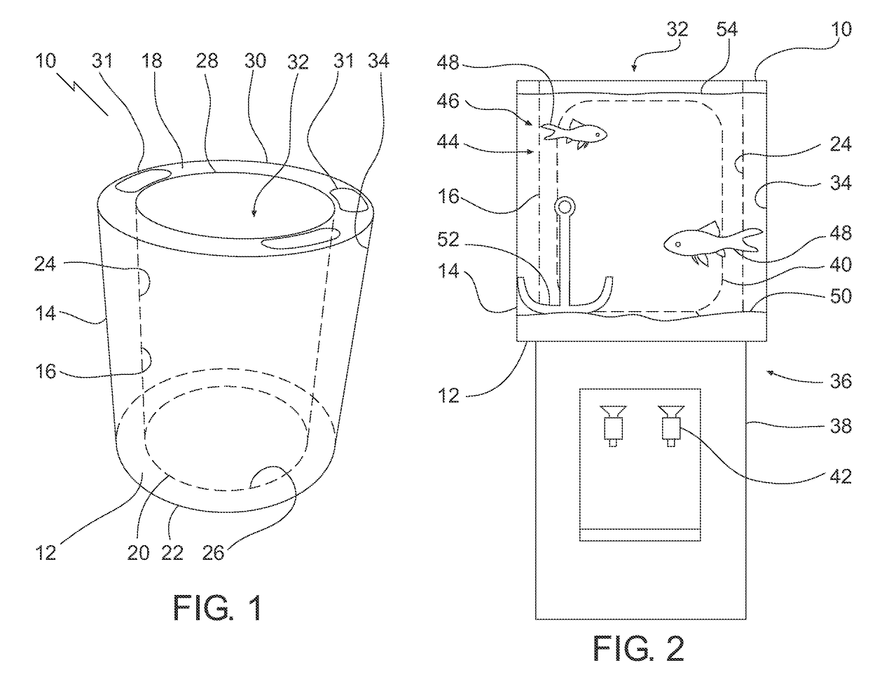

The method of visually enhancing inverted bottle water cooler will now be described with reference to FIG. 1 through 2.

Structure and Relationship of Parts

Referring to FIG. 1, an annular tank 10 is illustrated. Annular tanlk 10 has an annular bottom 12, an exterior sidewall 14, an interior sidewall 16, and an annular top 18. Annular bottom 12 has an inner circumference 20 and an outer circumference 22. Annular bottom 12 may be provided in the shape of a ring. Exterior sidewall 14 extends upwardly from outer circumference 22 of annular bottom 12. Exterior sidewall 14 may be constructed from transparent material, for example plastic, Plexiglas, or glass. Interior sidewall 16 extends upwardly from inner circumference 20 of annular bottom 12. Interior sidewall 16 defines a cylindrical central cavity 24. Inner circumference 20 and cylindrical central cavity 24 define a lower opening 26. Annular top 18 has an inner circumference 28, an outer circumference 30 and access holes 31. Exterior sidewall 14 attaches to outer circumference 30 of annular top 18. In the embodiment shown, interior sidewall 16 attaches to inner circumference 28 of annular top 18. Additionally, annular top 18 is provided in the shape of a ring with inner circumference 28 and cylindrical central cavity 24 defining an upper opening 32. Alternatively, annular top 18 may cover upper opening 32. Annular bottom and top 12 and 18, and sidewalls 14 and 16, enclose a tank cavity 34. Access holes 31 provide access to tank cavity 34. In the example shown, each of annular bottom 12, interior sidewall 16, and annular top 18 are provided as constructed from transparent materials. Alternatively, annular bottom 12, interior sidewall 16 and annular top 18 may be provided as constructed from non-transparent materials.

Referring to FIG. 2, annular tank 10 is positioned on a water cooler 36. Water cooler 36 has a base unit 38, and a water bottle 40. Water cooler 36 may be provided as any style of water dispensing device designed for the home, office, or other application. Base unit 38 has at least one water nozzle 42 for dispensing water contained in water bottle 40. Water bottle 40 may be inverted when received by base unit 38. Annular tank 10 is positioned over water bottle 40, with water bottle 40 being positioned within cylindrical central cavity 24 of annular tank 10. When in position over water bottle 40, bottom 12 of annular tank 10 rests upon base unit 38. Water bottle 40 may not reach upper opening 32. Alternatively, water bottle 40 may extend beyond upper opening 32.

Referring to FIG. 2, a visual attraction 44 may be positioned within tank cavity 34. Visual attraction 44 may be placed within tank cavity 34 through access holes 31 (shown in FIG. 1). Due to the transparency of exterior sidewall 14, visual attraction 44 is viewable through exterior sidewall 14. In the embodiment shown in FIG. 2, visual attraction 44 is provided as an aquarium setup 46. Aquarium setup 46 may have fish 48, rocks 50, and an anchor 52, illustrated as exemplary components of an aquarium. Aquarium setup 46 may also include water filled up to a water level 54. Alternatively, aquarium setup 46 may have other components found in a regular aquarium. Filters or air hoses (not shown), as exemplary components, may be inserted through access holes 31 (shown in FIG. 1). Additionally, fish 48 may be fed regularly using access holes 31.

Operation

A method of visually enhancing water cooler 36 having base unit 38 which receives inverted water bottle 40 is described as follows. Annular tank 10 is provided as described above with the contents of tank cavity 34 visible through the transparency of exterior sidewall 14. Additionally, if at least interior sidewall 16 is provided as constricted from transparent materials, the contents of cylindrical central cavity 24, including any water bottle 40 contained within, will be visible. Cylindrical central cavity 24 is selectively sized to slide of inverted water bottle 40. Annular tank 10 is slid over inverted water bottle 40 of water cooler 36 until water bottle 40 is positioned within cylindrical central cavity 24 with annular bottom 12 of annular tank 10 resting upon base unit 38. Annular tank 10 is then filled with visual attraction 44 viewable through the transparent exterior sidewall 14.

Variations

There may be numerous forms which visual attraction 44 can take. For example, and not to limit variations, visual attraction 44 could be a terrarium and or an entomology display. Annular tank 10 may have many variations in appearance and application. Tank 10 may be provided with a non-cylindrical shape with a cylindrical central cavity. It may also have a non-cylindrical central cavity, to fit 10 over a non-cylindrical water cooler. Tank 10 may have multiple chambers within tank cavity 34, for displaying different visual attractions 44 simultaneously.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one sldlled in the art that modifications may be made to the illustrated embodiment without departing from the spirit and scope of the invention as hereinafter defined in the Claims.

What is claimed is:

1. A method of visually enhancing water cooler having a base unit which receives an inverted water bottle, comprising the steps of:
providing an annular tank having an annular bottom with a transparent exterior sidewall extending upwardly from the bottom maling the contents of the annular tank visible and an interior sidewall extending upwardly from the bottom which defmes a cylindrical central cavity, the cylindrical central cavity being selectively sized to slide over an inverted water bottle;
sliding the annular tank over the inverted water bottle of the water cooler until the inverted water bottle is positioned within the cylindrical central cavity of the annular tank with the bottom of the annular tank resting upon the base unit;
filling the annular tank with a visual attraction viewable through the transparent exterior sidewall.

2. The method as defined in claim 1, the visual attraction being an aquarium

3. The method as defined in claim 1, the visual attraction being a terrarium.

4. The method as defined in claim 1, the visual attraction being an entomology display.

5. In combination:
a water cooler having a base unit which receives an inverted water bottle;
an annular tank having an annular bottom with a transparent exterior sidewall extending upwardly from the bottom and an interior sidewall extending upwardly from the bottom which defmes a cylindrical central cavity, the annular tank being positioned over the inverted water bottle of the water cooler with the inverted water bottle positioned within the cylindrical central cavity of the annular tank and the bottom of the annular tank resting upon the base unit;
a visual attraction being positioned within the annular tank and viewable through the transparent exterior sidewall.
